(19) United States
(12) Patent Application Publication
(10) Pub. No.: US 2026/0309031 A1
(43) Pub. Date: Oct. 8, 2026

(54) TURBINE ENGINE BLADE BLANK OBTAINED BY METAL CASTING AND METHOD FOR MANUFACTURING SUCH A BLANK

(71) Applicants: SAFRAN, PARIS (FR); SAFRAN AIRCRAFT ENGINES, PARIS (FR)

(72) Inventors: Ngadia Taha NIANE, MOISSY-CRAMAYEL (FR); Didier Maurice Marceau GUERCHE, MOISSY-CRAMAYEL (FR); Ming LONG, MOISSY-CRAMAYEL (FR); Hervé Bruno Marc OSMONT, MOISSY-CRAMAYEL (FR)

(21) Appl. No.: 19/476,967

(22) PCT Filed: Apr. 16, 2024
(86) PCT No.: PCT/FR2024/050506

§ 371 Date: Oct. 20, 2025

(30) Foreign Application Priority Data
Apr. 20, 2023 (FR) 2304006

(51) Int. Cl. F01D 5/12; B22D 25/02

(52) U.S. Cl. CPC F01D 5/12; B22D 25/02; F05D 2230/21

(57) ABSTRACT

A turbine engine blade blank obtained by metal casting has a first direction along which a blade, a platform, and a root are consecutively formed, the platform extending in a second direction substantially perpendicular to the first direction. The blade has a pressure-side face and a suction-side face which are connected to one another by a trailing edge and a leading edge. The root has retaining surfaces along the first direction which are intended to cooperate with corresponding surfaces of a turbine engine disc to radially hold the root during rotation. The blade blank also includes at least one shroud extending in a third direction substantially perpendicular to the first and second directions, this shroud connecting a retaining surface to the platform in the first direction.

### TECHNICAL FIELD

This disclosure relates to the field of turbine engine blades, in particular to the field of blade blanks obtained by casting a molten alloy in a mold using a technique of casting in removable material, for example lost wax casting, to obtain the final blades.

### PRIOR ART

Conventionally, the technique of lost wax casting first consists of creating a model, made of wax or of any other material that can subsequently be easily removed, of the part to be produced; this model is equivalent to the blade to be molded and may comprise an internal ceramic part forming a core that represents the cavities that are desired inside the blade. The wax model is then dipped several times in slurries composed of a suspension of ceramic particles in order to create a shell mold through operations known as stuccoing and drying. The shell mold thus envelops the wax model.

The shell mold is then dewaxed, an operation in which the wax or material constituting the original model is removed from the shell. After this removal, a ceramic mold is obtained in which the cavity reproduces all the shapes of the blade and which still contains, where appropriate, the ceramic core intended to generate the blade's internal cavities. The mold then undergoes a high-temperature heat treatment, or “firing,” which gives it the necessary mechanical properties.

The shell mold is then ready for manufacturing the metal part by casting. After verifying the internal and external integrity of the shell mold, the next step is to pour in molten metal, which fills the voids in the shell mold and then solidifies. This produces a blade blank, i.e. a semi-finished part substantially corresponding to the final blade but requiring one or more additional steps, such as surface treatment or finishing, to obtain a final blade that meets the required geometric criteria. In the field of lost wax casting, several solidification techniques and casting techniques are currently used, depending on the nature of the alloy and the expected properties of the part resulting from the casting. These may include, for example, columnar directional solidification (DS), single-crystal directional solidification (SX), or equiaxed solidification (EX).

After casting the alloy, the shell is broken off by a knockout operation. Then, where appropriate, the ceramic core that remains enclosed in the resulting blade blank is chemically removed during another step. The resulting metal blade blank then undergoes finishing operations that allow obtaining the finished part.

Examples of turbine blade production using the lost wax casting technique are given in the Applicant's patent applications FR2875425 and FR2874186.

FIG. 1 illustrates a turbine engine blade 10 known from the prior art. The arrow F in FIG. 1 indicates the direction of flow of gases through a turbine engine, the terms “upstream” and “downstream” being defined below relative to this arrow F.

In a first direction, also described as the longitudinal direction Z in the remainder of this description, such a blade 10 mainly comprises a root 11, a platform 12, and a blade 13. The blade 13 and the root 11 extend mainly in the longitudinal direction Z while the platform 12 extends mainly in a second direction, also described as the axial direction X in the remainder of this description, the axial direction X being substantially perpendicular to the longitudinal direction Z. The blade 10 further comprises a shank 18 connecting the root 11 to the platform 12. The blade 13 comprises a pressure-side face 14 (visible in FIG. 4) and a suction-side face 15 which are connected to each other downstream by a trailing edge 16 and upstream by a leading edge 17.

Conventionally, each blade 10 is mounted on a turbine disc, for example of a high-pressure turbine, the root 11 of the blade 10 being mounted in a groove in the rim of the disc, and the blade 13 extending radially outward from the root 11 of the blade 10. The root 11 of each blade 10 is at least partly received longitudinally and retained radially in one of the grooves in the rim of the disc. The root 11 of each blade 10 here has a cross-section (in a third direction, called the transverse direction Y in the remainder of this description) that is shaped like lobes, the root 11 longitudinally comprising a first lobe 21 and a second lobe 22. Each lobe 21, 22 comprises a retaining surface, respectively a first retaining surface 23 and a second retaining surface 24, also commonly called bulbs or bearing surfaces, intended to cooperate with a corresponding surface of a turbine engine disc. The first retaining surface 23 is positioned between the platform 12 and the second retaining surface 24. The first and second retaining surfaces 23, 24 radially hold the root 11 of the blade in the groove of the disc during rotation.

Furthermore, again as illustrated in FIG. 1, an upstream reinforcement portion 25, also commonly called an upstream spoiler, extends in the transverse direction Y, this direction Y being substantially perpendicular to the longitudinal direction Z and axial direction X, i.e. in a plane formed by the longitudinal direction Z and transverse direction Y, from the platform 12 to the root 11. In FIG. 1, the upstream reinforcement portion 25 is arranged close to the upstream face 26 of the root 11, and in particular in the longitudinal extension of the upstream face 26. The upstream reinforcement portion 25 thus comprises an upstream face, shared with the upstream face 26 of the root 11, a downstream face 29 of the upstream reinforcement portion, opposite the upstream face 26, and a longitudinal face 30 of the upstream reinforcement portion, joining the upstream and downstream faces of the upstream reinforcement portion 25. A downstream reinforcement portion 28 may also be arranged near the downstream face 27 of the root 11, in particular in the longitudinal extension of the downstream face 27.

During a conventional process for casting an alloy in a shell mold obtained using the lost wax casting technique, several blades are cast simultaneously in a casting tree. The alloy is introduced into the upper part of the tree, and thus fills the shell mold by gravity. The lower part of the mold is thus filled before the upper part. It is therefore understood that the solidification front of the alloy moves from the lower part to the upper part of the shell mold. According to current practice, the shell mold is arranged on the casting tree so that the blade 13 is positioned in the lower part and the root 11 is positioned in the upper part. As a result, the solidification front moves from blade 13 to root 11, and therefore the blade 13 is cast before the root 11.

The manufacture of blades from new metal alloys, including for example rhenium Re and/or ruthenium Ru, allows increased stress on these parts during their operation in comparison to commonly used alloys such as AM1. However, it has been observed that these new alloys give rise to the appearance of casting defects during solidification of the metal, which weakens the part and renders it non-compliant. Observed defects may for example include a shrinkage cavity, i.e. a defect in the form of a cavity forming in the solid part of a cast metal part and due to contraction of the metal during solidification. In particular, such a shrinkage defect may be observed in one of the upstream 25 or downstream 26 reinforcement portions of the blade 10.

The present disclosure therefore aims in particular to overcome these solidification defects which may appear in blade blanks obtained by casting a metal alloy.

### SUMMARY

To this end, the present disclosure proposes a turbine engine blade blank obtained by metal casting, comprising a first direction along which are consecutively formed a blade, a root, and a platform which extends in a second direction substantially perpendicular to the first direction, the blade comprising a pressure-side face and a suction-side face which are connected to each other by a trailing edge and a leading edge, the root comprising retaining surfaces along the first direction of the rotating blade which are intended to cooperate with corresponding surfaces of a turbine engine disc, wherein the blade blank comprises at least one shroud extending in a third direction substantially perpendicular to the first and second directions, this shroud connecting a retaining surface to the platform in the first direction.

The shroud may further have the following features, alone or in combination:
the shroud is formed at the upstream end of the blade root;
the shroud may be formed on the same side as the suction-side face and/or pressure-side face of the blade;
the shroud has a concave first curved face facing upstream;
the shroud has a convex second curved face facing downstream.

The features in which the shroud has a concave first curved face facing upstream and a convex second curved face facing downstream make it possible to ensure better repeatability of the casting process, and in particular to avoid the formation of protrusions during the casting process.

During solidification of the metal, these two features make it possible to avoid the formation of freckles (areas of local concentrations of impurities in the metal) and recrystallized grains.

The root may further comprise, on the same side as the suction-side face and/or the pressure-side face of the blade, in the first direction, a first retaining surface and a second retaining surface, the first retaining surface being positioned along the first direction between the platform and the second retaining surface, the shroud connecting the first retaining surface to the platform.

The platform may further comprise a reinforcing portion for the connection to the shroud, said reinforcing portion extending in the third direction and having a longitudinal face, the thickness of the shroud being between 0.2 and 0.8 times the thickness of the longitudinal face of the upstream reinforcing portion.

In the case of a wall thickness that is less than 0.2 times the thickness of the longitudinal face of the upstream reinforcement portion, the presence of an underthickness casting defect has been observed.

In particular, the volume of liquid metal to be poured from the reserve is insufficient and less sizeable in this case, which leads to faster solidification. Also, it has been observed that pouring this volume of liquid metal from the reserve creates areas with porosity defects or shrinkage cavity defects.

In the case of a wall thickness that is greater than 0.8 times the thickness of the longitudinal face of the upstream reinforcement portion, the presence of an overthickness casting defect has been observed.

In particular, during solidification of the metal, recrystallization types of thermomechanical problems were observed in this case: the monocrystalline criterion is no longer met, which weakens the part and can render it non-functional.

The present disclosure also proposes a method for manufacturing a turbine engine blade from a model made of a removable material having the geometry and dimensions corresponding to those of the blade blank defined above, the method comprising:
forming a shell mold around the model, the shell mold defining a cavity capable of obtaining said blade blank,
removing the model from the shell mold,
orienting the shell mold so that, for the blade blank, the first direction is oriented vertically and so that the head is in a low position and the root is in a high position, and
pouring metal into the shell mold, in the upper part of said mold.

During the method, a plurality of shell molds may be distributed circumferentially around an axis parallel to the first direction for the blade blank of each of the molds.

Next, the shroud is removed from the blade blank in order to obtain the blade.

### BRIEF DESCRIPTION OF DRAWINGS

Other features, details and advantages will become apparent upon reading the detailed description below, and upon analyzing the attached drawings, in which:

FIG. 1 shows a partial perspective view of a blade of the prior art, from its downstream face.

FIG. 2

FIG. 2 shows a partial perspective view of a blade blank according to the present disclosure, from its upstream face.

FIG. 3 shows a partial longitudinal view of the blade blank of FIG. 2, illustrating a shroud according to the present disclosure.

FIG. 4 shows a view of the blade blank of FIG. 2, from its upstream face.

FIG. 5 is a longitudinal view of the blade blank of FIG. 2.

FIG. 6A illustrates the casting of an alloy in order to obtain a blade of the prior art.

FIG. 6B illustrates the casting of an alloy in order to obtain a blade blank according to the present disclosure.

### DESCRIPTION OF EMBODIMENTS

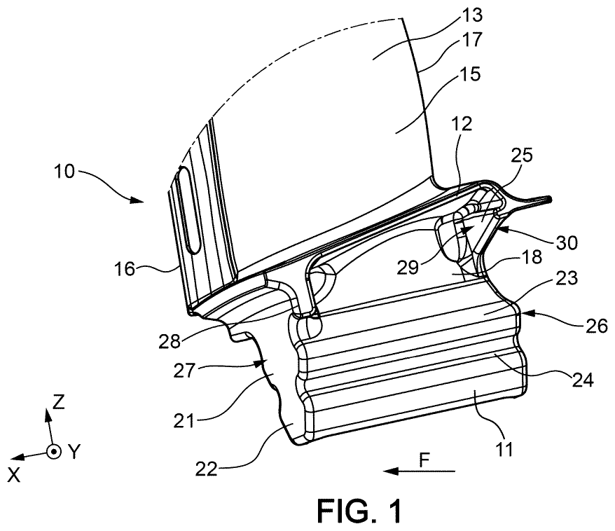

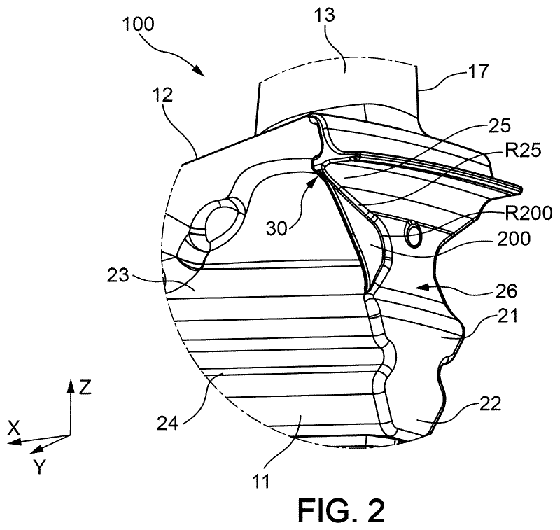

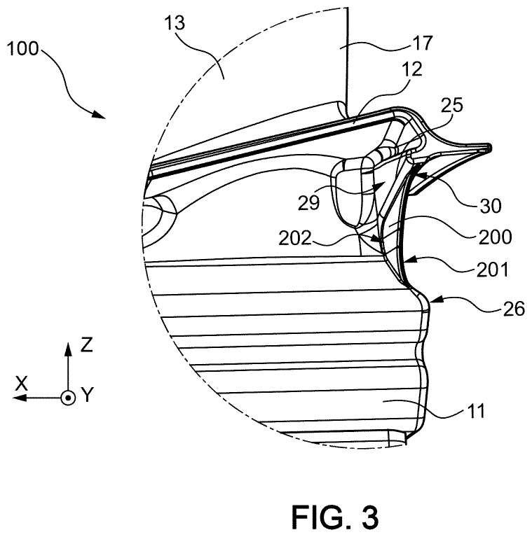

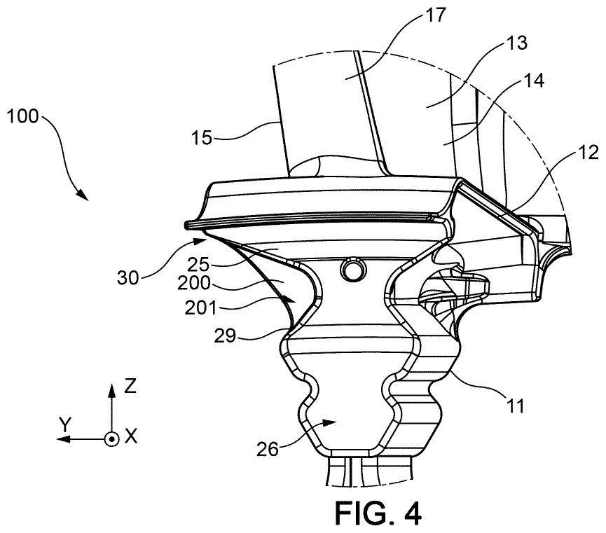

FIGS. 2 to 5 illustrate an example of a blade blank 100 according to the present disclosure, the blade blank 100 being only partially shown. The blade blank 100 is similar to the blade 10 shown in FIG. 1, except that it further comprises a shroud 200. The shroud 200 is arranged between the upstream reinforcement portion 25 and the first retaining surface 23, so as to form an extension of material between the upstream reinforcement portion 25 and the first retaining surface 23 which delimit it. The shroud 200 illustrated in FIGS. 2-5 is formed at the upstream end 26 of the root 11 of the blade 10. According to another example, the shroud may be formed at the downstream end 27 of the root 11. According to yet another example, each upstream and downstream end 26, 27 may each comprise a shroud.

In the example illustrated in the figures, the shroud 200 is formed on the same side as the suction-side face 15 of the blade 13. Alternatively, the shroud 200 may be formed on the same side as the pressure-side face of the blade 13. There may also be two shrouds provided, each arranged on one side of the faces of the blade 13.

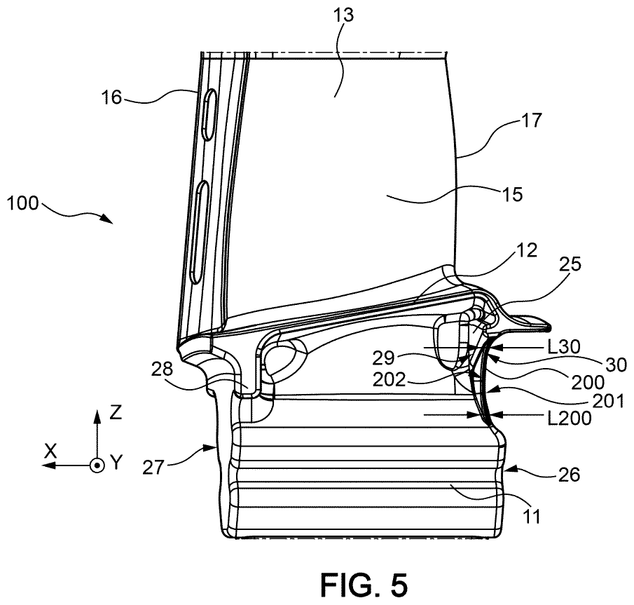

According to the example illustrated with better visibility in FIG. 5, the shroud 200 may have a first curved face 201, this being concave towards the upstream direction. The shroud 200 may further have a second curved face 202, this being convex towards the downstream direction. The first and second curved faces 201, 202 make it possible to remove the blade blank from the mold without this being more complicated than removing a blank that does not include the shroud 200.

The thickness L200 of the shroud 200 can be measured between the first and second curved faces 201, 202, in the axial direction X. This thickness L200 may be less than the thickness L30 of the longitudinal face of the upstream reinforcement portion 25. For example, the thickness L200 may be between 0.2 and 0.8 times the thickness L30 of the longitudinal face 30 of the upstream reinforcement portion. As a result, the shroud 200 and the upstream reinforcement portion 25 are connected together by a connection radius of the upstream reinforcement portion R25 and by a connection radius of the shroud R200, their ratio being less than or equal to 0.5 (R30/R200≤0.5), and preferably between 0.3 and 0.4, and for example equal to 0.37. These dimensions ensure that the shroud thickness does not extend beyond the connection radii of the upstream reinforcement portion, which makes it as simple as possible to machine the area after the shroud is removed.

Advantageously, the shroud 200 eliminates the solidification defects observed and in particular the shrinkage phenomenon detailed above, on the upstream reinforcement portion 25, or alternatively on the downstream end 27 if the shroud 200 is arranged there.

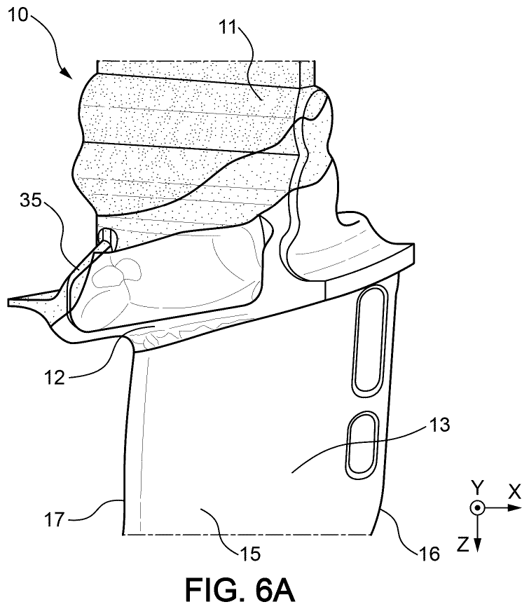

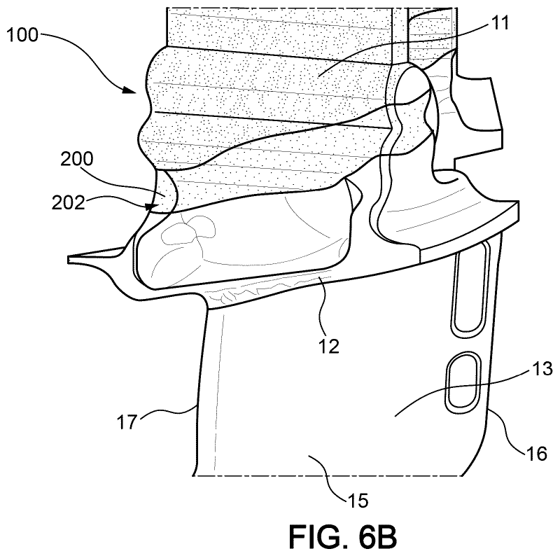

According to the example in which the shroud is arranged between the upstream reinforcement portion 25 and the first retaining surface 23, as illustrated in FIGS. 2 to 5, the shroud 200 provides a continuous front in the feeding of hot alloy to the upstream reinforcement portion, which improves the solidification of said portion. For comparison, FIG. 6A illustrates the solidification of the alloy during casting to form a conventional blade without a shroud, and FIG. 6B illustrates the solidification of the same alloy to form a blade blank comprising a shroud 200. In FIG. 6A, in the circled area, the solidification front is interrupted in the upstream reinforcement portion 25, which creates an isolated area 35 at the end 30 of the upstream reinforcement portion. There has thus already been solidification around this isolated area 35, which is then no longer supplied with molten alloy. During solidification, the alloy shrinks, which results in a reduction in the occupied volume. Due to the interruption in its supply of molten alloy, the isolated zone 35 therefore undergoes a shrinkage cavity phenomenon with no compensation by a supply of molten alloy, which results in a shrinkage cavity in this isolated zone 35. In FIG. 6B, the solidification front moves progressively from the platform 12 to the first retaining surface 23, i.e. with no interruption in the solidification front. The shroud 200 thus provides a molten alloy supply zone such that the supply to the upstream reinforcement portion 25 is not interrupted. By means of the shroud 200, the solidification front remains continuous in the zone of the upstream reinforcement portion 25.

However, the presence of the shroud 200 is not compatible with the final blade. The shroud 200 is therefore present only on the blade blank 100, and not on the final blade. Indeed, the presence of this shroud 200 prevents the longitudinal insertion of the blade root into the groove of the disc rim.

Furthermore, the shroud 200 can be defined by its volume. Preferably, the volume of the shroud is between 16.5 cm³ and 18.3 cm³ , which corresponds to a volume 3.5 to 5 times greater than the volume of the area where the shrinkage phenomenon observed in a blade of the prior art may occur.

To manufacture the blade blank 100 described above, the manufacturing method can be described as follows.

The method comprises a preliminary step of preparing a shell mold having a shape complementary to that of the blade blank one wishes to obtain. A shell mold is thus formed around a model made of removable material having the geometry and dimensions corresponding to those of said blade blank 100, the shell mold defining a cavity capable of obtaining said blade blank.

Several molds may be combined together in a casting tree so that several parts may be cast simultaneously. Each mold is oriented so that the obtained part is oriented with the blade downwards and the root upwards.

The alloy is then poured into the shell mold, from the upper part of said mold.

After the alloy cast in the mold has solidified, a blade blank 100 comprising the shroud 200 is then obtained. After the manufacture of said blade blank 100, it must still undergo one or more machining steps in order to obtain the final blade, and in particular a step in which the shroud 200 is removed from the blade blank 100, this shroud representing a non-functional volume of material. Finishing treatment on the longitudinal face 30 of the upstream reinforcement portion is then performed.

1. A turbine engine blade blank obtained by metal casting, comprising a first direction (Z) along which a blade (13), a platform (12), and a root (11) are consecutively formed, the platform (12) extending in a second direction (X) substantially perpendicular to the first direction (Z), the blade (13) comprising a pressure-side face (14) and a suction-side face (15) which are connected to each other by a trailing edge (16) and a leading edge (17), the root comprising retaining surfaces (23, 24) along the first direction (Z) which are intended to cooperate with corresponding surfaces of a turbine engine disc to radially hold the root during rotation,
characterized in that the blade blank (100) comprises at least one shroud (200) extending in a third direction (Y) substantially perpendicular to the first and second directions (Z, X), this shroud connecting a retaining surface (23) to the platform (12) in the first direction.

2. The blade blank according to claim 1, wherein the shroud (200) is formed at an upstream end (26) of the root (11).

3. The blade blank according to claim 1, wherein the shroud (200) is formed on the same side as the suction-side face (15) or the pressure-side face (14) of the blade (13).

4. The blade blank according to claim 1, wherein the root (11) comprises, on the same side as the suction-side face (15) or the pressure-side face (14) of the blade (13), in the first direction (Z), a first retaining surface (23) and a second retaining surface (24), the first retaining surface (23) being positioned along the first direction (Z) between the platform (12) and the second retaining surface (24), the shroud (200) connecting the first retaining surface (23) to the platform (12).

5. The blade blank according to claim 1, wherein the shroud (200) has a concave first curved face (201) facing upstream in the second direction (X).

6. The blade blank according to claim 5, wherein the shroud (200) has a convex second curved face (202) facing downstream in the second direction (X).

7. The blade blank according to claim 1, wherein the platform (12) comprises a reinforcing portion (25, 28) for the connection to the shroud (200), said reinforcing portion (25, 28) extending in the third direction (Y) and having a longitudinal face (30), a thickness (L200) of the shroud (200) being between 0.2 and 0.8 times a thickness (L30) of the longitudinal face (30) of the upstream reinforcing portion.

8. A method for manufacturing a turbine engine blade from a model made of a removable material having the geometry and dimensions corresponding to those of the blade blank (100) defined according to claim 1, the method comprising:
forming a shell mold around the model, the shell mold defining a cavity capable of obtaining said blade blank (100),
removing the model from the shell mold,
orienting the shell mold so that, for the blade blank, the first direction is oriented vertically and so that the head is in a low position and the root is in a high position, and
pouring metal into the shell mold, in the upper part of said mold.

9. The method according to claim 8, wherein a plurality of shell molds are distributed circumferentially around an axis parallel to the first direction for the blade blank of each of the molds.

10. The method according to claim 8, wherein the shroud (200) is removed from the blade blank (100) in order to obtain the blade.
